(19) United States
(12) Patent Application Publication
(10) Pub. No.: US 2006/0227048 A1
(43) Pub. Date: Oct. 12, 2006

(54) Electronic pitch over mechanical roll antenna

(75) Inventor: Alan Mak, Ottawa (CA)

Correspondence Address: TROUTMAN SANDERS LLP, 600 PEACHTREE STREET , NE, ATLANTA, GA, 30308, US

(73) Assignee: EMS Technologies, Inc., Norcross, GA (US)

(21) Appl. No.: 11/314,074

(22) Filed: Dec. 20, 2005

Related U.S. Application Data
(60) Provisional application No. 60/637,727, filed on Dec. 20, 2004.

(51) Int. Cl. H01Q 3/00

(52) U.S. Cl. 342/359; 343/757; 342/372

(57) ABSTRACT

A hybrid antenna for use with satellite communications systems that may be mounted to a fuselage of an airframe and contain an electronic phased-array assembly to electronically steer the pitch of the antenna beam fore and aft of the airframe and mechanically roll the phased-array assembly to provide below-the-horizon coverage.

### REFERENCE TO RELATED APPLICATIONS

This application claims priority to U.S. Provisional Patent Application Ser. No. 60/637,727, filed on Dec. 20, 2004, which is herein incorporated by reference.

### TECHNICAL DESCRIPTION OF THE INVENTION

The present invention is directed to an antenna, and more particularly to a hybrid antenna that can be both electronically steered and mechanically rotated to provide below-the-horizon coverage.

### BACKGROUND

The popularity of broadband access from homes and small offices by users has expanded in recent years due to the ease in which broadband provides access to large quantities of information. This access to large quantities of information allows users to leverage the information to allow them to work remotely and more efficiently. However, as user habits change and they become more mobile, they are expecting their access to the broadband access to change with them. The expectation that users will have broadband access from a mobile platform became a reality with the introduction of the INMARSAT's Swift64 high speed satellite communications (SATCOM) service, which allowed users to have broadband access from mobile platforms, such as airframes using satellite links. Expanding on this technology, INMARSAT in 2005 launched the Broadband Global Area Network (BGAN) service that provides mobile user with up to 432 kpbs of full-duplexed bandwidth from almost anywhere in the world. The BGAN service allows airline providers to enhance their customer's experiences by providing them with Internet access, telephone, entertainment, and information services at significantly reduced costs.

In order to bring the high-speed data to aircraft using the Swift64 and BGAN services, SATCOM services requires the use of ARINC 741 compliant high-gain antennas (HGAs). Current HGAs that are capable of supporting the Swift64 and BGAN services use either mechanically steered arrays or electronically steered phased-arrays to control the antenna beam. Current phased array antennas have several drawbacks. First, current phased-array antennas are relatively expensive due to the high quantity of phased-array elements required to achieve the high-gain performance. Second, current phased-array antennas are complicated to install. This is due to the fact that these antennas require the largest area on the fuselage of any antenna, which makes it very labor intensive to install the doublers for these antennas and makes it difficult and costly to prepare and maintain the paperwork required for Federal Aviation Administration (FAA) approval. Furthermore, since these HGAs are not considered standard equipment for an airframe, they do not have a “standard” footprint that is recognized by the FAA. Therefore, each HGA typically requires a unique footprint for mounting the antenna to the airframe, which requires additional engineering efforts and certification costs.

Another drawback to the phased-array antennas is that they are typically large and heavy. Existing phased-array antennas for SATCOM applications typically weigh sixty (60) pounds or more. The large weight causes a fuel penalty to operate the aircraft. Moreover, since these antennas are relatively large, they also produce a significant drag on the airframe, which also increase the fuel penalty. Moreover, due to the large size and weight of the current phased-array SATCOM antennas, the phased-array antennas are physically too large for installation an all but the largest tube-type airframes, such as the C-5 Galaxy, C-130 Hercules, KC-135, C-17, the Boeing 747, 757, 767, Airbus A380, Gulfstream GV, and similar airframes.

Mechanically-steered antennas are relatively lightweight and are less expensive to manufacture than phased-array antennas. However, mechanically steered antennas typically do have the same low profile as the phased-array antennas. Any attempt to mount the mechanically-steered antenna on the fuselage of the airframe results in unacceptable drag on the airframe. Therefore, because of their large profiles, mechanically-steered antennas are more suited for mounting on an aircraft tail section. A suitable radome material may be molded around the mechanically-steered antenna to approximately match the tail section and thereby minimize the drag exerted on the airframe due to the antenna. However, only the largest commercial airframes can support these tail-mounted antennas.

One solution to solve these problems has been the use a “hybrid” SATCOM antenna, which combines the mechanical rotation of the antenna beam in azimuth, while electronically scanning the antenna beam in elevation. Unfortunately, current hybrid SATCOM antennas have several drawbacks. First, current hybrid SATCOM antennas tend to be expensive to install because they may require Supplemental Type Certificate (STS) preparation, special doublers, specially trained Designated Engineering Representatives. Second, current hybrid SATCOM antennas require a relatively large footprint on the fuselage of the airframe, which prevents them from being installed on smaller fixed-wing and rotary-wing airframes. Last, current hybrid SATCOM antennas only provide hemispherical coverage.

Therefore, there is a continuing need for a lightweight hybrid SATCOM antenna. In particular, there is a need for a small, inexpensive, lightweight hybrid SATCOM antenna that may be easily and inexpensively adapted to be used with both large and small fixed and rotary-type airframes and is capable of providing below-the-horizon coverage.

### SUMMARY OF THE INVENTION

The present invention meets the needs described above in an inexpensive and lightweight hybrid SATCOM antenna that is suitable for use on all types of airframes. Generally described, the invention includes a hybrid SATCOM antenna having a phased-array assembly that contains a number of radiating elements for generating a beam pattern. The beam pattern is electronically steered around at least one axis to provide approximately ±90 degrees in pitch. The antenna also includes a mechanical drive unit for mechanically rotating the phased array assembly around a second axis to provide below the horizon coverage.

More particularly described, the invention describes a hybrid antenna having a one dimensional phased array assembly oriented substantially parallel to the longitudinal axis passing through the antenna. The phased array assembly may be electronically steered in pitch around latitudinal axis from approximately +90 degrees to approximately −90 degrees. Additionally, the phased-array assembly may also be mechanically rotated around the longitudinal axis, such that the angle of rotation is greater than ±90 degrees to provide below the horizon coverage.

Additionally, the antenna may include a pedestal that is used to attach the antenna to the fuselage of an airframe. The pedestal elevates the antenna above the fuselage of the airframe so that the mechanical rotation of the phased-array assembly around the longitudinal axis can provide below-the-horizon coverage. The pedestal also allows the antenna to be mounted to the fuselage using common antenna footprints. The pedestal is typically made from composite materials that allow it to be easily manufactured to accommodate different common antenna footprints For example, the pedestal may be made to conform to a Traffic Control Avoidance System (TCAS) antenna footprint, a INMARSAT low gain antenna footprint, a INMARSAT high gain antenna footprint, and the like.

The various aspects of the present invention may be more clearly understood and appreciated from a review of the following detailed description of the disclosed embodiments and by reference to the appended drawings and claims.

### BRIEF DESCRIPTION OF THE FIGURES

FIG. 1 is block diagram illustrating a satellite link to an aircraft using a hybrid antenna in accordance with some embodiments of the present invention.

FIG. 2 is an isometric view of a hybrid antenna in accordance with some embodiments of the present invention.

FIG. 3 is diagram of a typical Traffic Control Avoidance System (TCAS) antenna footprint.

FIG. 4 is a diagram of a typical INMARSAT low-gain antenna footprint.

FIG. 5 is a diagram of a typical INMARSAT high-gain antenna footprint.

FIG. 6 is a cross-sectional view of a hybrid antenna taken along the longitudinal axis in accordance with some embodiments of the present invention.

FIGS. 7A-7C are illustrations of examples of various phased-array assemblies in accordance with some embodiments of the present invention.

FIG. 8 is a block diagram illustrating a control circuitry for use with the hybrid antennal in accordance with some embodiments of the present invention.

FIGS. 9a and 9b, collectively known as FIG. 4, is a diagram of a cross sectional view of a hybrid antenna taken along the lateral axis in accordance with some embodiments of the present invention.

FIG. 10 is a logic flow diagram illustrating a method for electronically and mechanically steering a hybrid antenna to acquire a communications satellite in accordance with some embodiments of the present invention.

### DETAILED DESCRIPTION OF THE EMBODIMENTS

The present invention is typically embodied in compact and lightweight hybrid antenna for use on airframes for satellite communications (SATCOM) systems, such as the INMARSAT communications system. The hybrid antenna may contain a phased-array assembly having a number of radiating elements, which may be arranged in a one-dimensional array and oriented along the longitudinal axis of an airframe. The coverage area of the beam pattern produced by the radiating elements may be covered using a combination of mechanical and electronic beam-steering techniques. For example, the mechanical steering may enable the phased-array assembly to “roll” as the aircraft rolls, while the radiating elements may be electronically steered in pitch to maintain a lock on the communications satellite.

Limiting the electronic beam steering to only the pitch and the mechanical rotation of the phased-array assembly around the longitudinal axis may reduce the size and complexity of the antenna and allow the antenna to maintain below-the-horizon coverage. Furthermore, limiting the electronic steering of the beam to a single axis while reducing the mechanical rotation of the phased-array assembly around the longitudinal axis may result in a low-cost, light weight hybrid antenna that has minimal height, drag, and weight properties, which may make it suitable for installation on virtually all large, or small, and fixed-wing or rotary-winged airframes using common, pre-existing antenna footprints.

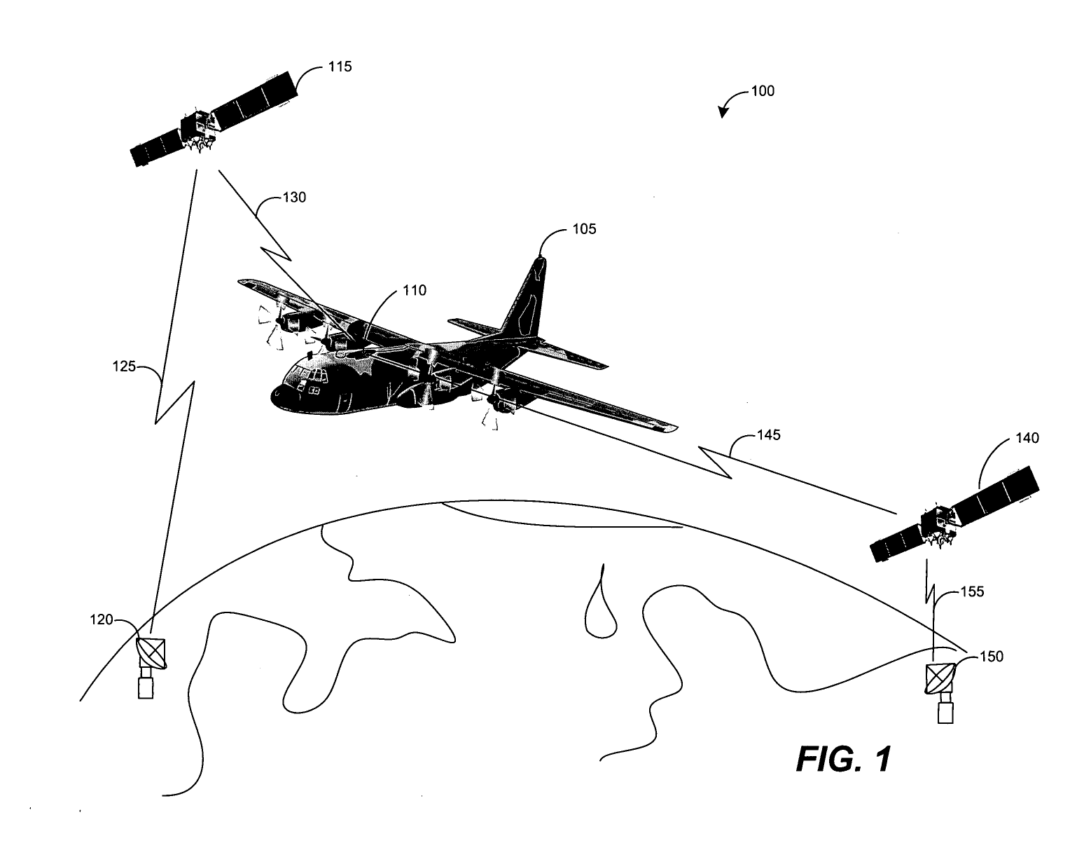

Turning now to the figures, in which like numerals refer to like elements through the several figures, FIG. 1 is a block diagram illustrating a typical environment 100, in which some embodiments of a hybrid antenna 110 in accordance with the present invention may be used. The hybrid antenna 110 may be mounted to the fuselage of an airframe 105 for communicating with a communications satellite 115. Although the airframe 105 in the figure is depicted as a fix-wing aircraft, those skilled in the art will appreciate that the airframe may also be a rotary-winged airframe. The communications satellite 115 may be part of a commercial SATCOM system, such as INMARSAT, or a military SATCOM system that provide a variety of high-speed, wideband services, such as video, voice, and data service to operators and passengers of the airframe 105. The communications satellite 115 will typically be located in a geosynchronous earth orbit (GEO) to provide the broadest and most complete coverage to transmit and receive data from ground station 120 through communications link 125. The information is then relayed to the hybrid antenna 110 on the airframe 105 through communications link 130. However those skilled in the art will appreciate that the communications satellite 115 may also be located in non-geosynchronous earth orbits, such as a low-earth orbit (LEO), or a high-earth orbit (HEO) without affecting the operation of the hybrid antenna 110. While in operation, the hybrid antenna 110 may maintain a communications link 130 with communications satellites 115 that lies within a substantially hemispherical region located above a horizontal plane, relative to the surface of the earth that passes through the center of the airframe 105. In addition, the airframe 105 may also communicate with satellite 140, which is located below the horizon or below the horizontal plane passing through the center of the airframe 105 over a communications link 145. The satellite 140 can then communicate with a ground station 150 that lies over the horizon and normally beyond the range of the hybrid antenna 110, over a communication link 155.

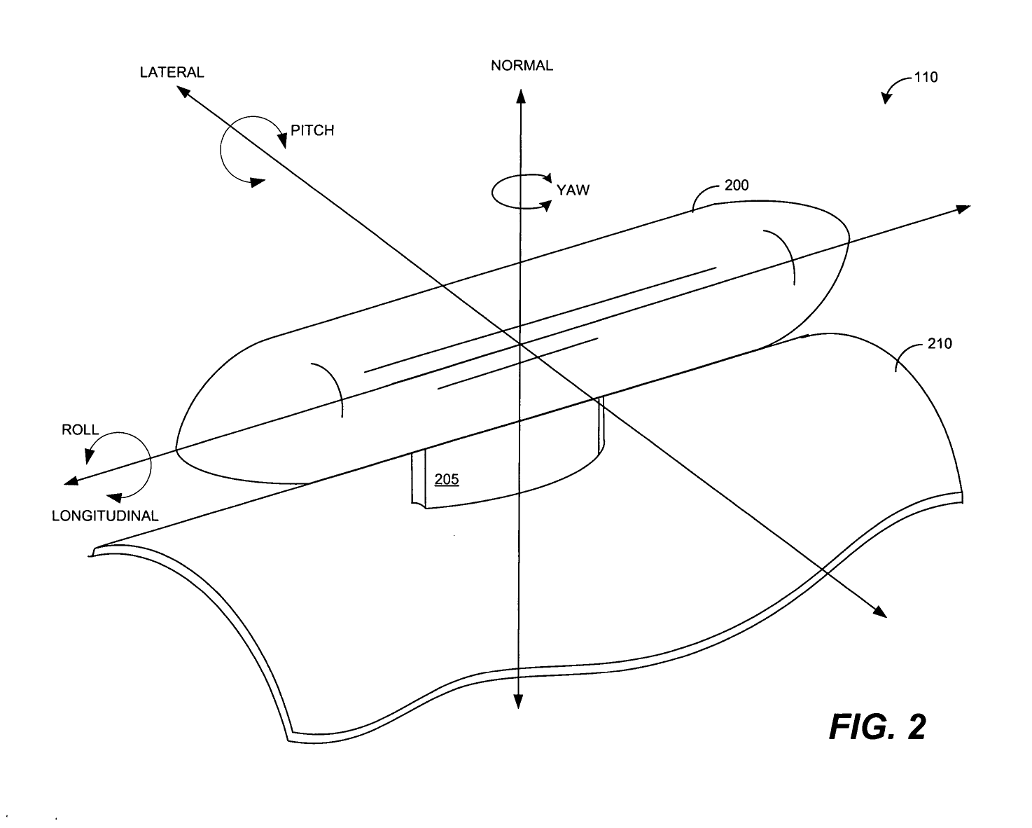

FIG. 2 is a diagram of the hybrid antenna 110 in accordance with some embodiments of the present invention. The hybrid antenna 110 includes a radome 200 that provides a protective cover to the radiating elements from environmental conditions. To minimize drag and air resistance the radome 200 is shaped as a “missile” that consists of an elongated tubular body and a substantially conical nose cone and tail sections. The radome 200 of the hybrid antenna 110 may be made of any dielectric material known in the art that allows radio-frequency signals within the appropriate frequency band to pass through with very little losses. The hybrid antenna 110 is typically oriented lengthwise along the longitudinal axis in relation to an airframe 105 to minimize the drag on the airframe 105.

The hybrid antenna 110 also includes a pedestal 205. The pedestal 205 has a first end that is secured to the bottom of the radome 200 and a second end that is attached to the fuselage 210 of the airframe 105. The pedestal 205 provides two main functions. First, the pedestal 205 is used to elevate the antenna 110 away from the fuselage 210 of the airframe 105 to insure that the antenna 110 has adequate clearance to provide below-the-horizon coverage. The pedestal 205 must be sufficiently strong to support the weight of the hybrid antenna 110, while still being relatively light in weight to minimize the overall weight of the hybrid antenna 110 and thereby minimize the resultant fuel penalty to the airframe 105. In an exemplary embodiment, the pedestal 205 is made from composite materials that provide a high strength-to-weight ratio. Such composite materials may include, but are not limited to carbon-based composite materials, polymer materials, ceramic materials, and the like. To minimize the overall weight of the hybrid antenna 110 and also minimize the overall drag on the airframe 105 the pedestal 205 is relatively small in size due to the small size of the radome 200. For example, in some embodiments, the pedestal 205 may have a length between approximately 5 inches and 20 inches, a width between approximately 0.5 and 2 inches, and a height between approximately 0.3 inches and 1.5 inches

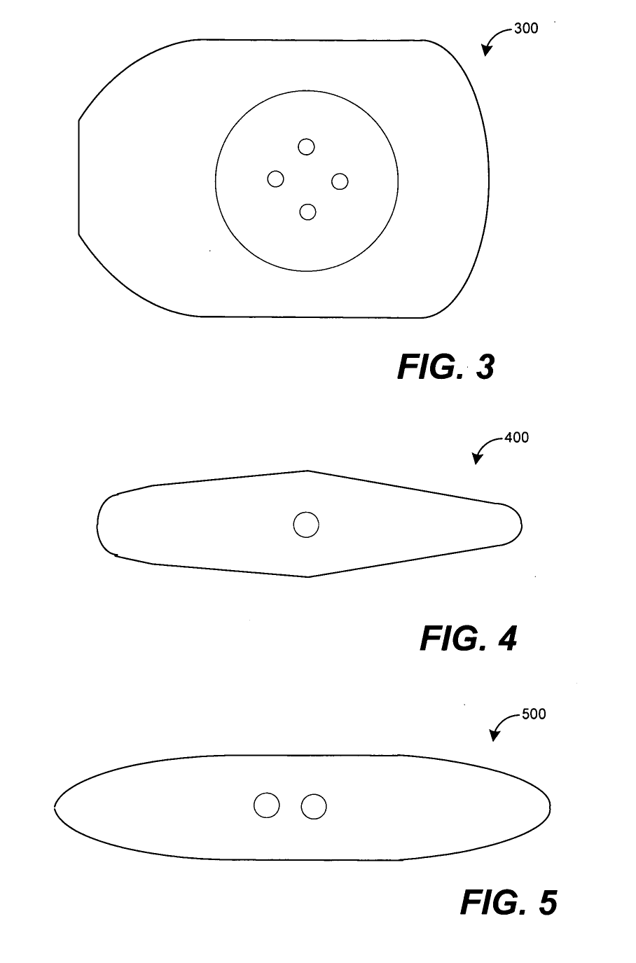

The second advantage provided by the pedestal 205 is that it may be adapted to fit a number of common, pre-existing antenna footprints. Because the pedestal 205 is made from composite materials, the base of the pedestal 205, which is in contact with the fuselage 210 can be shaped for optimum aerodynamic performance and conform to any common, pre-existing footprints. For example, in some embodiments, the base of the pedestal 205 may configured to attach to a standard Traffic Crash Avoidance System (TCAS) antenna footprint 300 shown in FIG. 3, an INMARSAT low gain antenna footprint 400 shown in FIG. 4, an INMARSAT high-gain antenna footprint 500 shown in FIG. 5, and the like. Those skilled in the art will appreciate that the base of the pedestal 205 may be formed to attach to other existing common antenna footprints without departing from the scope of the invention. Using common, pre-existing antenna footprints to mount the hybrid antenna 110 to the fuselage 210 through the pedestal provides several advantages over existing SATCOM antennas. First, using common, preexisting footprints greatly simplifies the cost and time of installing the hybrid antenna 110. Second, using common footprints facilitates the certification process required by the FAA, since all of the work for the certification process (e.g., the load analysis, the stress analysis, etc.) and the design analysis (e.g., doubler design and manufacturer, gasket design and placement, etc.) has already been performed for the common footprints. Consequently, the overall cost and complexity of installing the hybrid antenna 110 is greatly reduced as compared with conventional hybrid antennas.

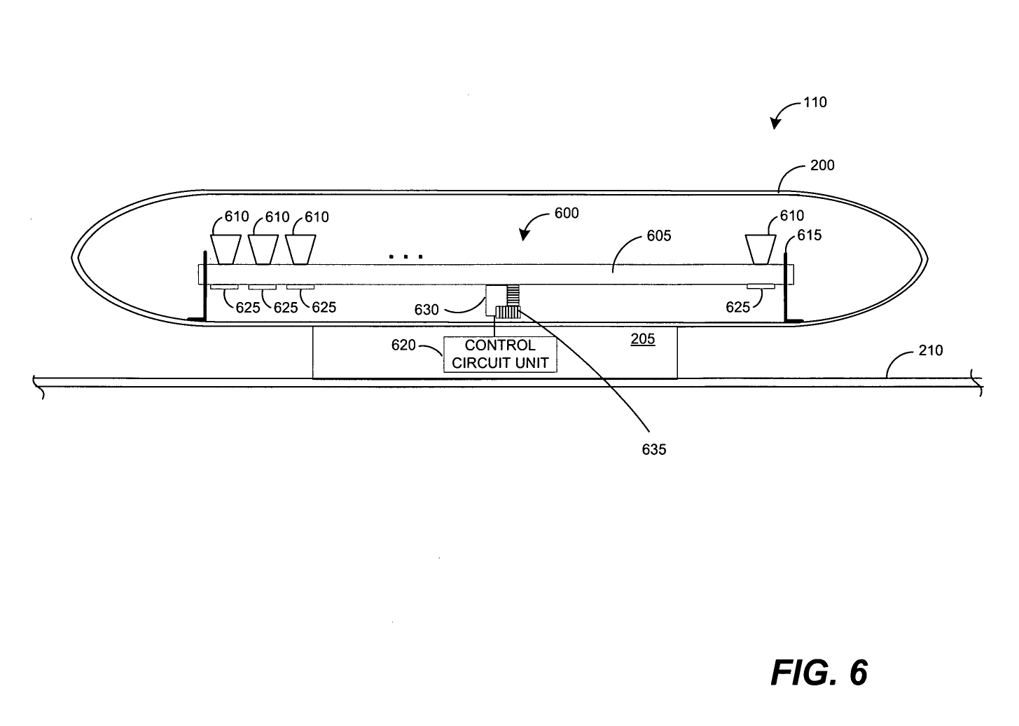

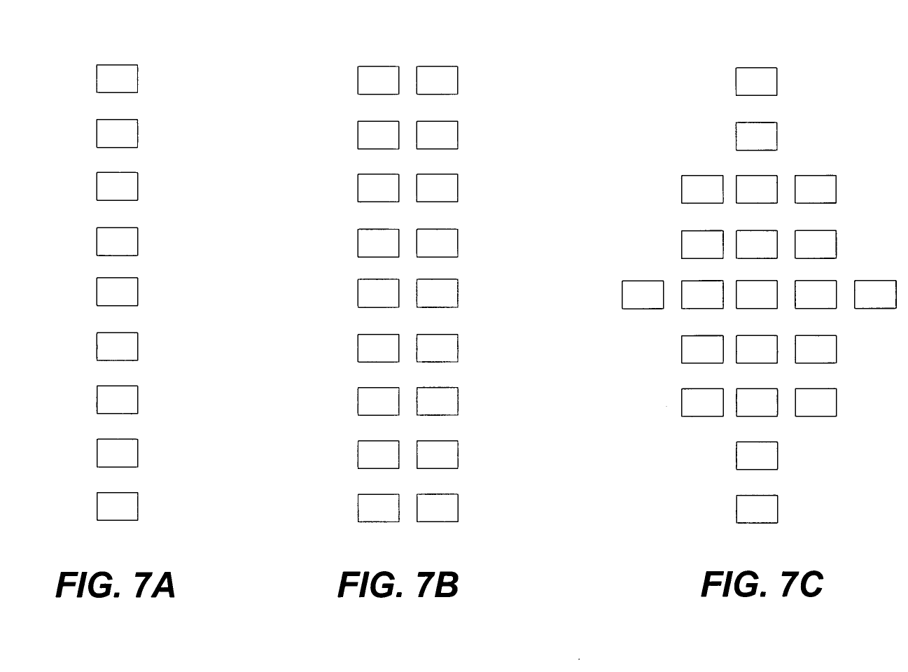

FIG. 6 is an illustration of a cross-sectional view of the hybrid antenna 110 taken along the longitudinal axis. The hybrid antenna 110 includes the radome 200, which is supported by the pedestal 205. The radome 200 surrounds a phased-array assembly 600. The radome 200 protects and shields the phased-array assembly 600 from environmental conditions, such as wind, rain, snow, dust, and the like and is transmissive to radio frequency radiation at the appropriate frequencies. The phased-array assembly 600 includes a support structure 605, which contains a discrete number of radiating elements 610. The radiating elements 610 may be arranged in an m×n array, where m is the number of elements 610 in a first dimension of the array, such as the column, and n is the number of radiating elements 610 in a second dimension of the array, such as the row. The m×n array allows the beam pattern formed by the phased-array assembly 600 to be electronically steered by adjusting the phases of the individual radiating elements 610 using phase shifters 625 disposed on the backside of the support structure 605. In an exemplary embodiment, the phased-array assembly 600 is formed from a 1×n array that contains a single row of n radiating elements 610 oriented along the longitudinal axis of the airframe 105. An example of a 1×n array is shown in FIG. 7A. This arrangement of radiating elements 610 produces a beam pattern that can be electronically steered about a single axis, i.e., the lateral axis. Thus, the beam pattern may be scanned in elevation, or pitch, between approximately −90 degrees to approximately +90 degrees around the lateral axis. Although the phased-array assembly has been described in terms of a 1×n array, those skilled in the art will appreciate that phased-array assembly 600 may include two or more columns of radiating elements 610 oriented along the longitudinal axis to provide increased gain for the hybrid antenna 110. An example of a 2×n array is shown in FIG. 7B. Additionally, the number of radiating elements 610 in each column does not have to be the same. For example, the phased-array assembly 600 may have a pattern of radiating elements 610, in which the rows toward the center of the array contain more radiating elements than the rows toward the end of the array to provide an increased gain along a central portion of the beam pattern. An example of this array-type is shown in FIG. 7C. The patterns of radiating elements 610 shown in FIGS. 7A-7C are merely meant to be examples of phased-array assemblies 600 that may be used in the present invention and are not meant to limit the pattern or number of radiating elements that may be used. In fact, it should be obvious to those skilled in the art that the phased-array assembly 600 may contain any number of radiating elements 610 arranged in any number of different patterns without departing from the scope of the invention.

The support structure 605 is also rotatably mounted to a pair of brackets 615 within the radome 200. The brackets 615 allow the phased-array assembly 600 to be mechanically rotated around the longitudinal axis. Typically, the phased-array assembly 600 may have a range of angular rotation from approximately −Θ degrees to approximately +Θ degrees around the longitudinal axis. In some embodiments, Θ may be greater than 90 degrees to allow the phased-array assembly 600 to provide below the horizon coverage. To provide the required mechanical rotation of the phased-array assembly 600, the antenna 110 may include a drive mechanism 630 to physically rotate the phased-array assembly 600 from approximately −Θ degrees to approximately +Θ degrees, around the longitudinal axis. In an exemplary embodiment, the drive mechanism 630 is a motor connected to the support structure 605 through a gear assembly 635. Alternatively, the drive mechanism 630 may be pulleys, cables, servo motors, or any other mechanism known in the art to provide the required mechanical rotation to the phased-array assembly 600.

The hybrid antenna 110 may also include a control circuit unit 620, which is typically located within the pedestal 205 and holds various electronic components, associated with the operation of the antenna 110. Although the control circuit unit 620 is shown as being located in the pedestal 205, those skilled in the art will appreciate that the control circuit unit 620 may also be located within the fuselage 210 of the airframe 105 without departing from the scope of the invention.

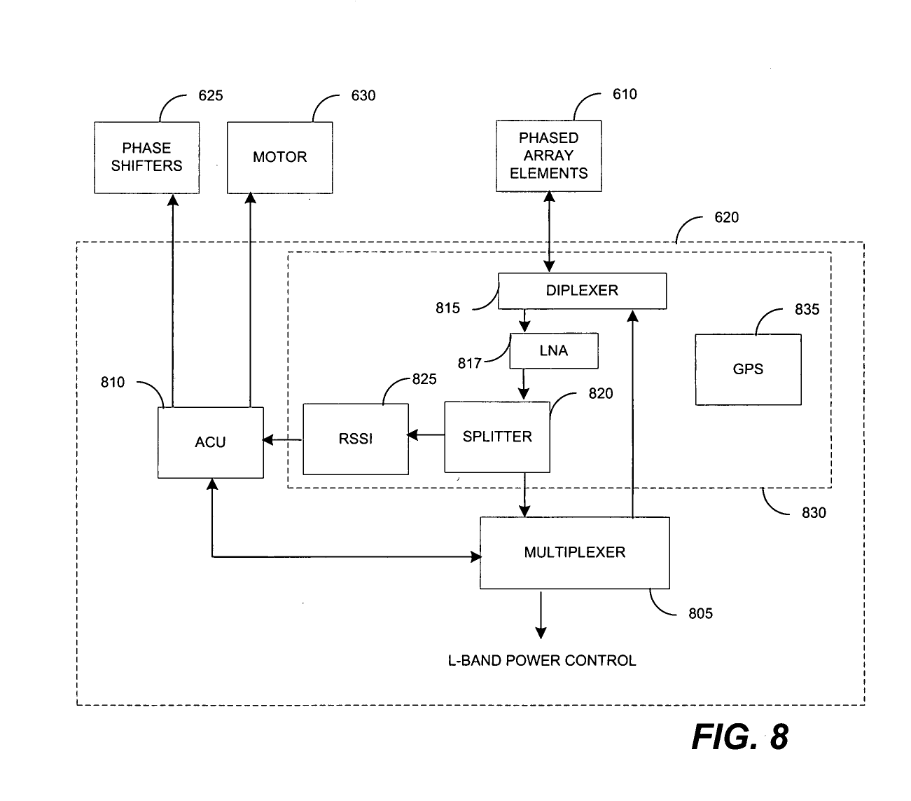

FIG. 8 is a block diagram illustrating an exemplary embodiment of the control circuit unit 620. The control circuit unit 620 includes a multiplexer 805, which multiplexes the power, the control signal, and the communications signal together to simplify the connectivity between the phased-array assembly 600 and the avionics by means of a single connection through the fuselage 210. The multiplexer 805 receives the communications signal from the radiating elements 610 through a pointing, acquisition, and tracking (PAT) subsystem 830 for acquiring, locking on, and tracking the appropriate communications satellite. The PAT subsystem 830, for instance, may contain a Global Positioning System (GPS) receiver 835 for acquiring GPS signals to determine the airframe's exact latitudinal and longitudinal coordinates, memory storage units that may contain a priori information regarding the orbital characteristics for multiple communications satellites, a microprocessor, and the like.

The received signal passes through a diplexer 815, which allows for two-way communications. The received signal is then passed through a low noise amplifier (LNA) 817 and then to a splitter 820, where part of the received signal is removed and passed to a receive signal strength indicator (RSSI) 825. The RSSI 825 uses the strength of the received signal to produce a control signal to maintain the beam pattern focused on a spatial point based on the maximum received signal strength. The control signal is then passed from the RSSI 825 to an antenna control unit (ACU) 810, which sends the appropriate control signals to the phase shifters 625 and the motor 630 to maintain the beam pattern pointing at the appropriate communications satellite. The ACU 810 is directly connected to the phase shifters 625 to control the pitch of the beam pattern by adjusting the individual phases of each phase shifter 625 to position the beam at a given location about the latitudinal axis. The ACU 810 is also connected to the motor 630 to accurately rotate the support structure 605 about the longitudinal axis. In an exemplary embodiment, the motor 630 is a step motor, which incrementally steps, or rotates the support structure 605 based on the digital signals received from the ACU 810.

The hybrid antenna 110 may produce several advantages over current hybrid antenna systems. First, the one dimension array requires fewer radiating elements 310 than current hybrid antennas that use two-dimensional arrays, which reduces the cost of the antenna 110. Secondly, a one-dimensional array reduces the overall cost and complexity of the antenna 110. Since the signal processing capacity required for steering phased-array assembly 600 in one dimension is much less than the signal processing capacity required for steering a phased array assembly 600 in two dimensions, the amount of hardware needed to process the signal is reduced, which reduces the overall costs. Third, because there are fewer radiating elements, the overall weight and size of the phased-array assembly 600 is reduced as compared to conventional hybrid SATCOM antennas. For example, in some embodiments the radome 200 of the antenna 110 may be less than approximately thirty (30) inches in length, and less than approximately 6.5 inches in diameter. Because the overall size and weight of the hybrid antenna 110 may be reduced, the hybrid antenna 110 is more aerodynamic than current hybrid antennas, thereby reducing the drag on the airframe 105. Finally, because the hybrid antenna 110 is lighter and cheaper than current hybrid SATCOM antennas, and because the hybrid antenna 110 may be adapted to fit common antenna footprints, the hybrid antenna 110 is limited to installation on only large tubular military and civilian airplanes, but may be economically installed on a wide array of fixed-wing and rotary wing airframes.

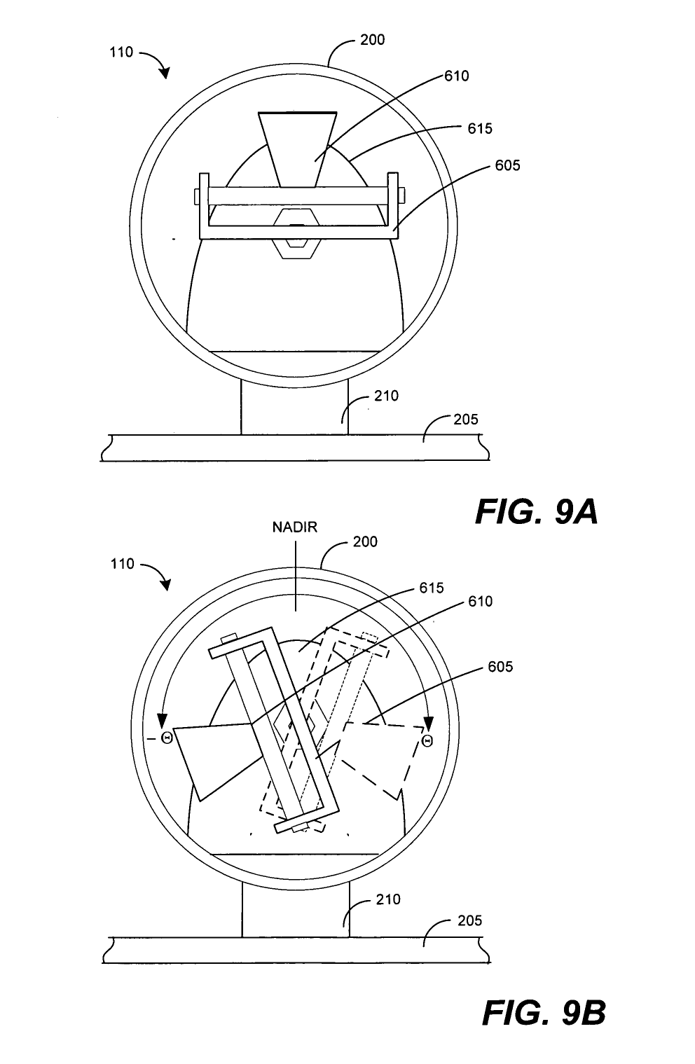

FIGS. 9a and 9b, collectively known as FIG. 9, illustrates the mechanical rotation of the phased-array assembly 600 around the longitudinal axis. FIG. 9A illustrates a cross-sectional view of the antenna 110 taken along the lateral axis. The cross section illustrates the phased-array assembly 600 in the neutral position, or when the phased-array assembly 600 is oriented at a zero degree rotation around the longitudinal axis. FIG. 9b illustrates a cross-sectional view of the antenna 110 taken along the lateral axis illustrating a range of motion for the phased-array assembly 600. The phased array assembly 600 is rotatably connected to the bracket 615 and may be rotated between approximately −Θ degrees to approximately +Θ degrees around the longitudinal axis. In an exemplary embodiment of the present invention Θ is greater than 90 degrees, thereby allowing the hybrid antenna 110 to provide below the horizon coverage. In an exemplary embodiment, Θ is approximately 105 degrees about either side of the nadir, which translates to a total rotation of the phased array assembly 605 of approximately 210 degrees about the longitudinal axis. The ability of the hybrid antenna 110 to provide below the horizon coverage has several advantages over existing hybrid antenna. First, the hybrid antenna 110 is capable of acquiring and maintaining a communications link with satellites beyond the operational capability of existing hybrid SATCOM antennas due to the greater angle of rotation around the longitudinal axis. This allows for a more robust communications, since the hybrid antenna 110 is able to maintain a communications link with a satellite that lies below the horizon. Second, the communications link is much less likely to be broken when an airframe makes an adjustment in attitude, such as executing a roll maneuver while communicating with a satellite having a low elevation angle. In these circumstances, rolling the airframe 105 may cause the satellite to drop “below the horizon” of the airframe 105. The mechanical steering of the hybrid antenna 110 may enable the phased-array assembly 600 to “roll” as the airframe 105 rolls to maintain a lock on the satellite and maintain the communications link. Finally, the ability of the hybrid antenna 110 to maintain below the horizon coverage allows the airframe 105 to maintain a greater range of operational capabilities.

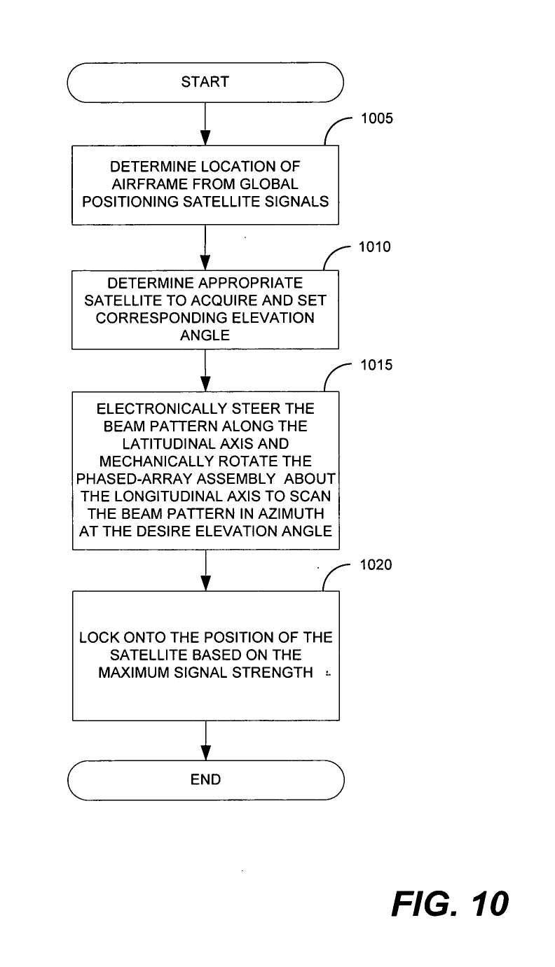

FIG. 10 is a logic flow diagram illustrating a routine 1000 for pointing the hybrid antenna 110 by electronically scanning the pitch of the beam pattern and mechanically rotating the phased array assembly 600 around the longitudinal axis to acquire a communications satellite. Routine 1000 begins at 1005, in which the coordinate data identifying the location of the airframe is determined using the GPS receiver 835 (FIG. 8) located within the control circuitry unit 630. At 1010, the coordinate data may be used by the PAT subsystem 840 in combination with an a-priori knowledge of the general location the communications satellites stored in a look-up table to determine the nearest and most suitable communications satellite to establish a communications link. For example, The PAT subsystem 840 may contain a lookup table that may contain a list of all current communications satellites and their orbital characteristics, such as inclination angle, elevation, orbital period (for non-geosynchronous satellites), nadir, and the like. The PAT subsystem 840 may then calculate the appropriate elevation angle for the phased-array assembly 600 for acquiring the communications satellite, which may be passed on to the ACU 810, which in turn provides inputs to the phase shifters 625 to electronically steer the beam pattern to the appropriate elevation angle.

Routine 1000 may then proceed to 1015, in which the beam pattern is electronically scanned in elevation as the phased-array assembly 600 is simultaneously rotated about the longitudinal axis to scan the beam pattern in azimuth while maintaining the beam pattern at the desired elevation angle. This process may be continually repeated until the desired communications satellite is acquired.

At 1020, once the desired communications satellite is acquired, minor adjustments may made electronically to the pitch of the main beam and to the rotation of the phased array assembly 600 until the main beam of the beam pattern is positioned so that the maximum signal strength from the communications satellite is received. At this point, the PAT subsystem 840 locks on the azimuth to maintain the received maximum signal strength from the communications satellite. The electronic steering of the beam pattern in conjunction with the GPS input and the signal from the RSSI unit 825 is used to maintain focus of the beam pattern at the desired spatial point, i.e., in elevation angle and azimuth. At this point, the beam pattern can be electronically dithered based on the signal strength from the RSSI unit 825 to take advantage of the fast dynamic response of electronic beam steering that cannot be achieved mechanically with the limitation of the antenna elements inertia or motor power.

Other alternate embodiments will become apparent to those skilled in the art to which an exemplary embodiment pertains without departing from its spirit and scope. Accordingly, the scope of the present invention is defined by the appended claims rather than the foregoing description.

I claim:

1. A hybrid antenna, comprising:
a phased-array assembly comprising a plurality of radiating elements for generating a beam pattern;
a plurality of phase shifter for electronically steering the beam pattern around a lateral axis; and
a mechanical drive unit for mechanically rotating the phased array assembly around a longitudinal axis,
wherein the phased array assembly has a range of rotation to provide below the horizon coverage.

2. The hybrid antenna of claim 1, wherein the plurality of radiating elements are arranged in one-dimensional array.

3. The hybrid antenna of claim 2, wherein the one-dimensional array is oriented substantially parallel to the second axis.

4. The hybrid antenna of claim 3, further comprising a radome for enclosing the phased-array assembly.

5. The hybrid antenna of claim 4, wherein the antenna is mounted to an airframe.

6. The hybrid antenna of claim 1, wherein the range of rotation around the second axis is approximately greater than ±90 degrees.

7. The hybrid antenna of claim 5, further comprising a pedestal to raise the phased array assembly a predetermined height above the airframe.

8. The hybrid antenna of claim 6, wherein the pedestal may be mounted to a preexisting antenna footprint on the airframe.

9. The hybrid antenna of claim 8, wherein the preexisting antenna footprint comprises a Tactical Crash Avoidance System (TCAS) footprint.

10. The hybrid antenna of claim 5, wherein the airframe is a fixed-wing airframe.

11. The hybrid antenna of claim 5, wherein the airframe is a rotary-winged airframe.

12. The hybrid antenna of claim 7, wherein the pedestal and radome are comprised of a material selected from a list consisting of fiberglass, carbon-based composites, polymers, and ceramics.

13. A hybrid antenna attached to an airframe, comprising:
a phased-array assembly comprising a plurality of radiating elements for generating a beam pattern;
a radome surrounding the phased-array assembly;
a plurality of phase shifter for electronically steering the beam pattern around a first axis; and
a mechanical drive unit for mechanically rotating the phased array assembly around a second axis,
wherein the phased array assembly may be mechanically rotated through a range of rotation to provide below the horizon coverage.

14. The hybrid antenna of claim 13, further comprising:
a pedestal attached to the radome having a predefined shape that is configured to attach to a preexisting antenna footprint on the airframe.

15. The hybrid antenna of claim 14, wherein the preexisting antenna footprint comprises a Tactical Crash Avoidance System (TCAS) footprint.

16. The antenna of claim 13, wherein the first axis comprises a normal axis associated with the airframe, and the second axis comprises a longitudinal axis associated with the airframe.

17. The hybrid antenna of claim 13, wherein the range of rotation around the longitudinal axis is approximately greater than ±90 degrees.

18. The hybrid antenna of claim 13, wherein the airframe is a fixed-wing airframe.

19. The hybrid antenna of claim 13, wherein the airframe is a rotary-winged airframe.

20. The hybrid antenna of claim 13, wherein the pedestal and radome are comprised of a material selected from a list consisting of metals, metal alloys, fiberglass, carbon-based composites, polymers, and ceramics.

21. A method, comprising:
acquiring a satellite communications (SATCOM) signal from a satellite using a phased-array assembly;
electronically steering a beam pattern along a first axis to maintain acquisition of the signal; and
mechanically rotating the phased-array assembly around a second axis to maintain acquisition of the signal.

22. The method of claim 21 further comprising:
determining whether the signal has a maximum signal strength;
if the determination is made that the signal is a maximum signal strength then leaving the beam patter in its current alignment; and
if the determination is made that the signal is not a maximum signal strength then electronically steering the beam pattern along a first axis and mechanically rotating the phased-array assembly around a second axis to maintain the maximum signal strength.

23. The method of claim 21, wherein acquiring a communications signal comprises:
obtaining a Global Positioning Satellite (GPS) system signal to identify the position of the phased-array assembly;
determining orbital characteristics for the satellite;
aim the phased-array assembly in the direction of the satellite based on the orbital characteristics; and
lock the phased-array assembly onto the satellite based on a maximum signal strength.

24. The method of claim 21, wherein the phased-array assembly comprises a plurality of radiating elements arranged in a one dimensional-array oriented along the second axis.

25. The method of claim 21, wherein the phased-array assembly may be mechanically rotated about the second axis through a range of rotation to provide below the horizon coverage.

26. The antenna of claim 23, wherein the range of rotation around the second axis is approximately greater than ±90 degrees.
